(19) United States
(12) Patent Application Publication
(10) Pub. No.: US 2022/0401298 A1
(43) Pub. Date: Dec. 22, 2022

(54) HOUSING FOR A SPA-SIDE CONTROLLER

(71) Applicant: Stanley Viva, NAPLES, FL (US)

(72) Inventor: Stanley Viva, NAPLES, FL (US)

(21) Appl. No.: 17/858,455

(22) Filed: Jul. 6, 2022

Related U.S. Application Data
(60) Provisional application No. 63/212,758, filed on Jun. 21, 2021.

(51) Int. Cl. A61H 33/00

(52) U.S. Cl. CPC A61H 33/60; A61H 33/005

(57) ABSTRACT

A housing for a spa-side controller is disclosed, including a base having a top side and a bottom side. An aperture is positioned on the bottom side to permit the access of a controller to an electrical circuitry in electrical communication with a spa. A lid is pivotally engaged with the top side of the base, the lid permitting selective access to the controller.

### CROSS-REFERENCE TO RELATED APPLICATIONS

The present application claims priority to U.S. Provisional Patent Application No. 63/212,758 filed Jun. 21, 2021, entitled “HOUSING FOR A SPA-SIDE CONTROLLER” which is hereby incorporated by reference in its entirety.

### TECHNICAL FIELD

Embodiments of the invention relate to weatherproof and weather-resistant housings and more specifically relate to weatherproof and weather-resistant housings for spa-side controllers.

### BACKGROUND

Many people enjoy hot tubs (also known as spas, among other names) in their homes, apartment complexes, condominium, or community and public recreation area to relax, or for hydrotherapy. In-ground spas include a plumbing system to direct water through a filtration system, suction system, and induced air or air blower system. An electric or natural gas heating system heats the water to a desired temperature. One or more of these systems may be in communication with a controller having an interface to allow the user to control the heat and/or system of jets spaced underwater throughout the tub.

When considering in-ground spas, the controller is often positioned on the side of the spa to allow the user or maintenance personnel convenient access from inside or outside of the spa. The controller provides an interface to access the spas computing system which is in electrical communication with the various operational systems of the spa. In such, the controller includes various sensitive electrical components which are exposed to the elements. Often, the controller must be replaced due to damage from sun exposure, dust, moisture, and impact.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments provided herein relate to a housing for a spa-side controller is disclosed, including a base having a top side and a bottom side. An aperture is positioned on the bottom side to permit the access of a controller to an electrical circuitry in electrical communication with a spa. A lid is pivotally engaged with the top side of the base, the lid permitting selective access to the controller.

The housing is configured to contain the spa-side controller, thus protecting the controller from damage due to sun exposure, dust, moisture, impact, etc. In such, the housing allows the user to access the controller via a lid which may be openable or removable to permit access to the interface of the controller.

In one aspect, the lid is pivotally engaged via a hinge.

In one aspect, the hinge is stainless steel.

In one aspect, the hinge is positioned at a rear side of the housing.

In one aspect, a left side and a right side of the lid form a seal with a top left edge and a top right edge of the base.

In one aspect, the base includes a recessed portion to receive the lid.

In one aspect, the lid is constructed of a transparent material to permit the viewing of the controller.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a perspective view of the housing for a spa-side controller, according to some embodiments;

FIG. 2 illustrates a perspective view of the housing for a spa-side controller, according to some embodiments;

FIG. 3 illustrates a perspective view of the housing for a spa-side controller, according to some embodiments;

FIG. 4 illustrates a front elevation view of the housing for a spa-side controller, according to some embodiments,

FIG. 5 illustrates a rear elevation view of the housing for a spa-side controller, according to some embodiments,

FIG. 6 illustrates a side elevation view of the housing for a spa-side controller, according to some embodiments,

FIG. 7 illustrates a top plan view of the housing for a spa-side controller, according to some embodiments; and

FIG. 8 illustrates a bottom plan view of the housing for a spa-side controller, according to some embodiments

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom.

Before describing in detail exemplary embodiments, it is noted that the embodiments reside primarily in combinations of components related to the system. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein relate to a housing for a spa-side controller which is configured to contain the spa-side controller, thus protecting the controller from damage due to sun exposure, dust, moisture, impact, etc. In such, the housing allows the user to access the controller via a lid which may be openable or removable to permit access to the interface of the controller.

The spa-side controller may be any controller commonly used in in-ground spas. The controller includes a user interface which includes a plurality of buttons to control the various systems of the spa. For example, the controller may be used to control the heat, direct water or air through the jet systems, control the filter, run diagnostics, etc. The controller includes electrical circuitry in communication with a power source, and in communication with the spa control modules. The interface may be touch-screen, buttons, or other use-selectable controls.

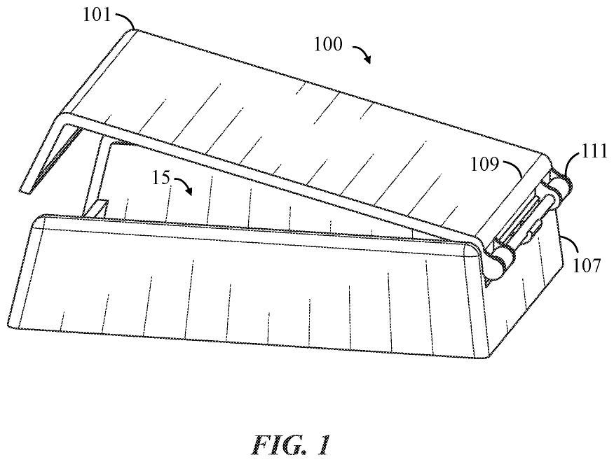

In reference to FIGS. 1-8, the housing 100 for the controller (not shown) is displayed. The housing 100 is dimensioned to enclose the controller when a lid 101 is closed while permitting a user, maintenance personnel, or other operator to open the lid 101 to access the controller. In such, the housing has a height, length, and width sufficient to cover the controller and protect the controller from the elements, impact, and accidental contact with the controls.

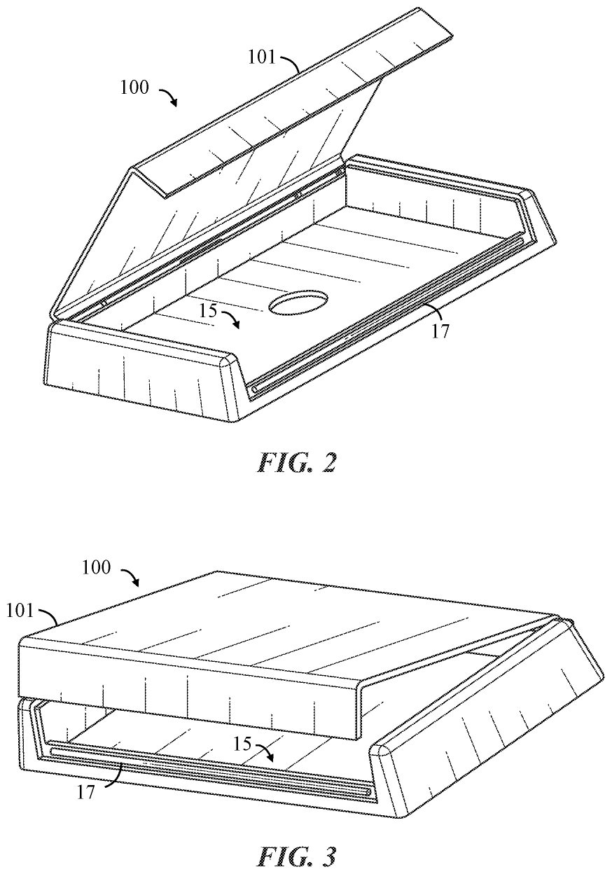

FIG. 1-3 illustrate perspective views of the housing 100 for spa-side controller. The housing 100 includes an interior cavity 15 which is dimensioned to house the spa-side controller therein. In such, the spa-side controller is contained within the housing when the lid 101 is closed. The housing 100 provides a protective barrier from debris, the elements, moisture, impact, and accidental contact which may result in inadvertent changes to the spa settings. The lid 101 is pivotable via hinge 111 positioned near or on the top edge 109 at the rear side 107 of the housing 100. A latch 17 (see FIG. 2 and FIG. 3) may retain the lid 101 in a closed configuration and allow the lid 101 to be selectively opened and closed by the user.

In some embodiments, an aperture 125 (see FIG. 2) is positioned on the bottom side 123 of the base 103 of the housing 100. The aperture 125 allows for electrical wiring and/or mounts of the spa-side controller to pass through the base 103, thus retaining operational functions of the spa-side controller when positioned within the housing 100.

In some embodiments, the latch 17 may include a locking mechanism to allow the user to selectively lock and unlock the lid 101. In such, the user can selectively prevent and/or grant access to the spa-side controller within the housing 100.

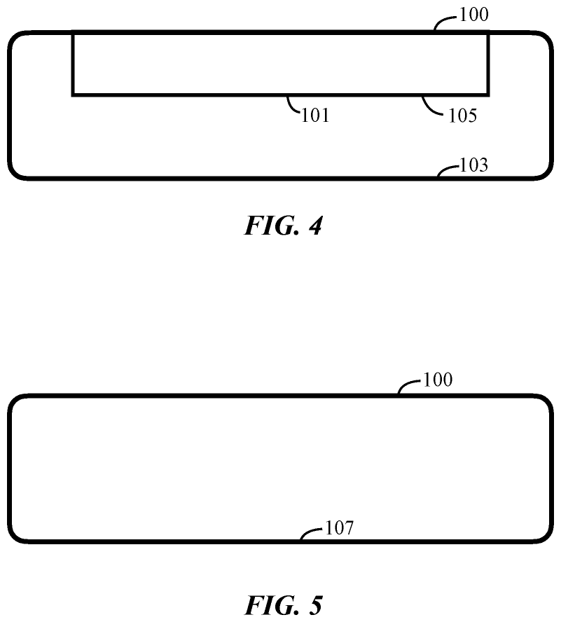

FIG. 4 illustrates a front elevation view of the housing 100 for the spa-side controller. The housing 100 includes a base 103 which is affixed to a surface. The surface may be a ground surface, or surface of the siding of the spa such that the housing 100 will not move. The base includes a recessed portion 105 to fittingly engage with the lid 101. In such, the lid 101 rests within the recessed portion and interfaces with the base 103 to provide a hermetic seal or nearly hermetic seal therebetween to prevent fluids, debris, or other materials from entering the interior of the housing 100. FIG. 5 illustrates a rear elevation view of the housing 100 for the spa-side controller. The rear side 107 of the housing may be a continuous surface.

In some embodiments, the base 103 may be removably engaged with a receiver to allow the housing to be removed during maintenance of the controller or other components associated therewith.

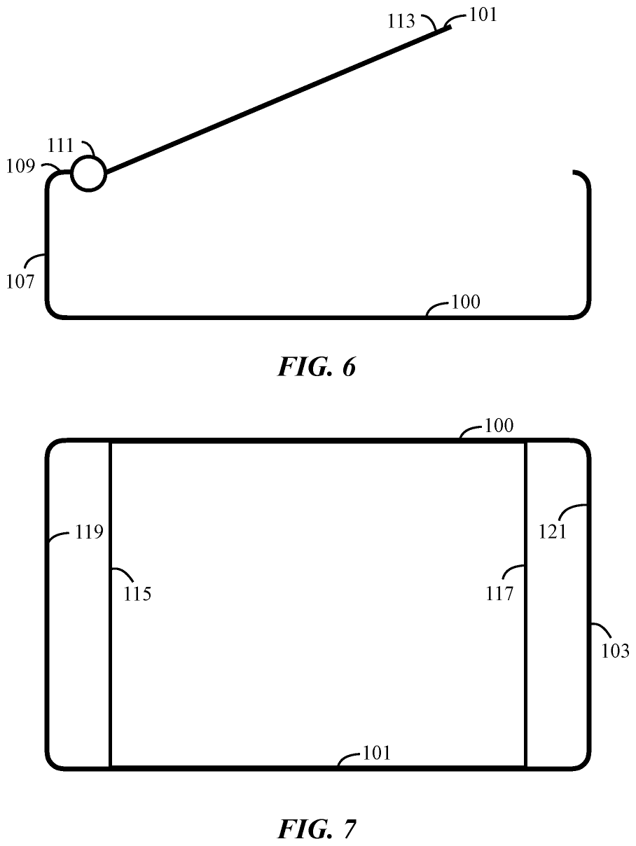

FIG. 6 illustrates a side elevation view of the housing 100 for a spa-side controller. The rear side 107 and/or a top edge 109 of the rear side 107 may include a hinge 111 to allow the lid 101 to pivot when opening or closing the lid 101. In such, the user lifts the front side 113 of the lid 101 to open and close the lid 101 to gain access to the controller within the housing 100. When closed, the lid 101 encloses the controller to prevent the entrance of moisture, debris, or other materials. This allows for the selective access to the controller to adjust the spa settings or to service the controller or associated components.

FIG. 7 illustrates a top plan view of the housing 100 for the spa-side controller. The lid 101 includes a left edge 115 and a right edge 117 to form a sufficient seal with the top left side 119 and top right side 121 of the base 103. The lid 101 may be constructed of a sufficiently resilient material to deter damage to the controller within the interior of the housing 100. The lid 101 may be constructed, at least partially, of a transparent or semi-transparent material to allow the user, maintenance personnel, or other operator to view the controller without opening the lid 101.

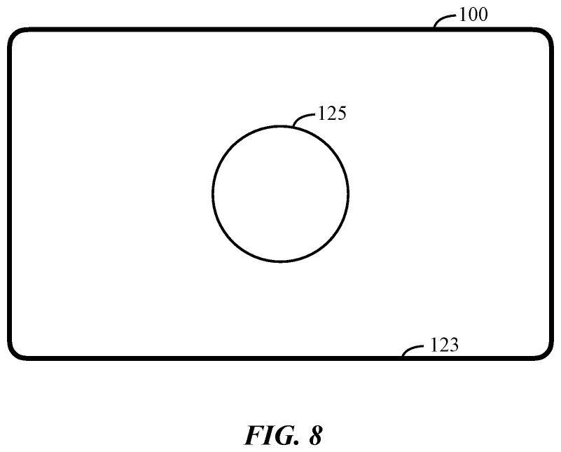

FIG. 8 illustrates a bottom plan view of the housing 100 for the spa-side controller. The bottom side 123 of the base 103 includes an aperture 125 to permit the electrical components of the controller to be positioned therethrough. In such, the housing 100 may be affixed to the controller via the aperture 125. During installation, the housing 100 is affixed to a surface and the controller may then be installed within the housing 100.

In some embodiments, the housing 100 is provided in various sizes to accommodate the variable sizes of spa-side controllers. In such, the size, shape, and configuration of the housing 100 may be adjusted to compliment the size, shape, and configuration of the controller.

In some embodiments, the hinge 111 may be constructed of a sufficiently rigid material including metals, metal alloys, rigid plastics, etc. In particular, a stainless steel hinge 111 may be used to prevent rust and degradation of the hinge 111 over time and in the presence of salt water.

In some embodiments, the lid 101 may include a locking mechanism to secure the lid 101 to the base 103 and to prevent unwanted access to the controller when in a locked position. The locking mechanism may include a latch to secure the lid 101 and prevent unintended opening of the lid 101 without locking the lid 101.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A housing for a spa-side controller, comprising:
a base including a top side and a bottom side;
an aperture positioned on the bottom side, the aperture to permit the access of a controller to an electrical circuitry;
a lid pivotally engaged with the top side of the base, the lid permitting selective access to the controller.

2. The housing for a spa-side controller of claim 1, wherein the lid is pivotally engaged via a hinge.

3. The housing for a spa-side controller of claim 1, wherein the hinge is stainless steel.

4. The housing for a spa-side controller of claim 1, wherein the hinge is positioned at a rear side of the housing.

5. The housing for a spa-side controller of claim 1, wherein a left side and a right side of the lid form a seal with a top left edge and a top right edge of the base.

6. The housing for a spa-side controller of claim 1, wherein the base includes a recessed portion to receive the lid.

7. The housing for a spa-side controller of claim 1, wherein the lid is constructed of a transparent or semi-transparent material.

8. A housing for a spa-side controller, comprising:
a base including a top side and a bottom side;
an aperture positioned on the bottom side, the aperture to permit the access of a controller to an electrical circuitry in electrical communication with a spa;
a lid pivotally engaged with the top side of the base, the lid permitting selective access to the controller; and
a latch to retain the lid in a closed configuration.

9. The housing for a spa-side controller of claim 8, further comprising a locking mechanism in communication with the latch.

10. The housing for a spa-side controller of claim 9, wherein the housing provides a weatherproof barrier.

11. The housing for a spa-side controller of claim 9, wherein the lid is pivotally engaged via a hinge.

12. The housing for a spa-side controller of claim 10, wherein the hinge is stainless steel.

13. The housing for a spa-side controller of claim 11, wherein the hinge is positioned at a rear side of the housing.

14. The housing for a spa-side controller of claim 12, wherein a left side and a right side of the lid form a seal with a top left edge and a top right edge of the base.

15. The housing for a spa-side controller of claim 13, wherein the base includes a recessed portion to receive the lid.

16. The housing for a spa-side controller of claim 15, wherein the housing is constructed of a transparent or semi-transparent material.

17. The housing for a spa-side controller of claim 14, wherein the lid is constructed of a transparent or semi-transparent material.

18. A housing for a spa-side controller, comprising:
a housing including a base having a top side and a bottom side;
an aperture positioned on the bottom side, the aperture to permit the access of a controller to an electrical circuitry in electrical communication with a spa;
a lid pivotally engaged with the top side of the base via a hinge, the hinge positioned on a top edge of a rear side, the lid permitting selective access to the controller; and
a latch to retain the lid in a closed configuration, the latch including a locking mechanism to permit a user to selectively lock and unlock the lid.
